(19) United States
(12) Patent Application Publication
(10) Pub. No.: US 2008/0133369 A1
(43) Pub. Date: Jun. 5, 2008

(54) Automated business process

(76) Inventor: Alien Garcia, Naples, FL (US)

Correspondence Address: JAMES RAY & ASSOCIATES, 2640 PITCAIRN ROAD, MONROEVILLE, PA, 15146, US

(21) Appl. No.: 11/999,292

(22) Filed: Dec. 5, 2007

Related U.S. Application Data
(60) Provisional application No. 60/868,576, filed on Dec. 5, 2006.
(60) Provisional application No. 60/868,574, filed on Dec. 5, 2006.

(51) Int. Cl. G06Q 30/00; G06Q 50/00

(52) U.S. Cl. 705/14; 705/1; 705/15

(57) ABSTRACT

A method of operating a business to insure accurate order entry and provide increased efficiency and satisfaction to a customer of the business. The method includes providing a system having a predetermined number of specific job based touch screen interfaces with a computer having a server. The touch screen interfaces is selected from a group consisting of a customer interface, an order taker interface, a delivery interface and a supervisors interface. The method further provides the system with an interface which enables such customer to place an order for at least one of a product or service. The availability of a particular service or product can be continually updated. Upon entering a customer's order is sent to an appropriate party who will read and fill the order. The final step includes delivering the order to the customer.

### CROSS REFERENCE TO RELATED APPLICATION

This patent application is related to and claims priority from U.S. Provisional Patent Application Ser. No. 60/868,576 filed Dec. 5, 2007 and to U.S. Provisional Patent Application Ser. No. 60/868,574 filed Dec. 5, 2007 titled “Virtual Mesero POS Table”, and being filed concurrently herewith. Each of these applications is incorporated herein by reference thereto.

### FIELD OF THE INVENTION

The present invention relates, in general, to methods of operating a business and, more particularly, this invention relates to an improved method of operating such business which facilitates the entry, filling and delivery of a customer's order and their payment when using a credit card.

### BACKGROUND OF THE INVENTION

Although as will become apparent to those persons skilled in the art, the method of operating a business to be described in detail hereinafter can be applied advantageously to a number of different types of business it will be discussed hereinafter as it would apply to the restaurant business.

Prior to the conception and development of the present invention, as is generally well known in the prior art, orders for food and beverages are given to either a waiter or waitress at the table who then in turn bring back the order when it is prepared. In some instances the person taking the order may not have heard correctly or the chef may not have been able to read their writing and as a result the order or some of the order may have to be sent back. Obviously, this is costly to the restaurant owner and frustrating to the patron due to the added wait.

Further, when the patrons have relatively small children with them and the restaurant is extremely busy it becomes quite difficult to entertain the children and keep them occupied. This may happen for example when the chefs are backed up due to the large number of orders to be processed.

### SUMMARY OF THE INVENTION

The present invention provides a method of operating a business to insure accurate order entry and to provide increased efficiency and satisfaction to a customer of such business. The method includes at least the steps of first providing a system having a predetermined number of specific job based touch screen interfaces with a computer. Such computer having a server and wherein the touch screen interfaces are selected from a group consisting of a customer interface, an order taker interface, a delivery interface and a manager interface. Further, providing such system with an interface which enables the customer to place an order which can be continually updated as certain items are sold out. The method also includes entering the customer's order and sending it to an appropriate party who will read such order and prioritize it by time received and then fill such customer's order by an appropriate party. Lastly, such method includes delivering the order to such customer.

### OBJECTS OF THE INVENTION

It is, therefore, one of the primary objects of the present invention to provide a method of operating a business which will substantially minimize the number of human errors which can occur in filling and delivering orders.

Another object of the present invention is to provide a method of operating a business which will significantly increase customer satisfaction with the business.

Still another object of the present invention is to provide a method of operating a business which is automated and user friendly.

Yet another object of the present invention is to provide a method of operating a business which will significantly improved productivity and reduce staffing costs.

An additional object of the present invention is to provide a method of operating a business which is interactive with a number of different stations having different functions.

A still further object of the present invention is to provide a method of operating a restaurant business which will enhanced the patron's dining pleasure.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF A PRESENTLY PREFERRED AND VARIOUS ALTERNATIVE EMBODIMENTS OF THE INVENTION

Taught hereinafter is a method of operating a business. The method will ensure a more accurate order entry and it will provide increased efficiency and satisfaction to a customer of such business. The method at least includes the steps of providing a system which has a predetermined number of specific job based touch screen interfaces with a computer having a server. These touch screen interfaces will be selected from a group consisting of a customer interface, an order taker interface, a delivery interface and a manager interface.

Additionally, the system is provided with an interface which enables such customer to place an order and in which the interface can be continually updated as certain items are sold out. The order placed by the customer is then forwarded to an appropriate party who will read such order and prioritize it according to time received.

The customer's order is filled by such appropriate party and is thereafter delivered to such customer. In the presently preferred embodiment of the invention the method of operating a business is particularly well suited for a restaurant. In this case such appropriate party is at least one of a chef and a bartender. In the most preferred embodiment of the invention, such appropriate party is each of the chef and such bartender.

Further, according to the present invention, the system will preferably include an interface which enables the customer to view a menu prior to placing their order with at least one of such chef or bartender. ve the capability of continuously updating the menu as certain items thereon become unavailable for serving.

It is also presently preferred that the appropriate party further includes a hostess and such method includes allowing the hostess to interface with at least one of a reservation manager program, a table status monitor, a full restaurant overview, an incoming and an outgoing call log, instant messenger service, entertainment controls and will allow the hostess to communicate pre-selected messages to the patrons' table.

In the presently preferred embodiment of the invention, the method further includes providing another interface in the system which enables such patron to at least one of access pre-selected advertising, a predetermined number of internet web sites, various television programs and various preselected games. However, it is even more preferred that at least two of such pre-selected advertising, internet web sites, television programs and preselected games can be accessed by the patron. It is most preferred that each of such pre-selected advertising, internet web sites, television programs and preselected games can be accessed by the patron.

According to the invention, the method will only allow certain personnel access to all of the several interfaces that can be made available within the system. Finally, the method contemplates allowing a patron to pay their bill at their table.

It can be seen from the above description that the invention provides an automated business process which utilizes existing computer technology to create a more effective restaurant procedure. This system can be used in conjunction with the unique Virtual Mesero POS Table, taught in my co-pending application, and features specific job-based, touch-screen interfaces. The hostess interface is designed with a reservations manager program, table status monitor, full restaurant overview, incoming and outgoing call log, instant messenger feature, HD moods controls, as well as allow the hostess to communicate customized welcome messages to the POS Table. After the customer enters their order via the client interface that features advertising access and of course, the establishment's menu selections, the chef reads the incoming orders, which are prioritized by time of order and then by table number, and begins preparation accordingly. This chef interface is also capable of instant messenger alerts, order correction, completed orders review and allows the real-time enabling or disabling of the restaurant's dishes from the menu, meaning that if the restaurant runs out of a necessary ingredient, the dish is immediately not offered to the customers. This program, designed into color-coded tables, will allow the chef to easily determine the dish's desired sides or read any special requests. The Automated Business Process's waitress interface contains complete order processing by seat and table, offers visual depiction of table arrangements, allows the user to correct or review orders, determine order status for the customer, and is equipped with a HD Moods control and instant messenger. It will also log user activity to further facilitate in the process of running a restaurant. The system features a manager interface that enables the owner or manager to more easily oversee the business. This features complete restaurant accounting, entrance-to-exit process review, an inventory control system, a products database, and access to user accounts with activity logging. It will also feature an instant messenger and a backup system. The invented process moves the customer from the hostess to the table (where they enter their order) to the chef to the waitress, to the check out for payment and back to the waitress who will clear the table so that the process can begin again. All interfaces run to a main server and are, with the exception of management, limited to specific job descriptions.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A method of operating a business to insure accurate order entry and provide increased efficiency and satisfaction to a customer of said business, said method comprising the steps of:
(a) providing a system having a predetermined number of specific job based touch screen interfaces with a computer having a server, said touch screen interfaces selected from a group consisting of a customer interface, an order taker interface, a delivery interface and a manager interface;
(b) providing said system with an interface which enables said customer to place an order which can be continually updated as certain items are sold out;
(c) entering said customer's order which is sent to an appropriate party who will read said order and prioritize by time received;
(d) filling said customer's order by said appropriate party; and
(e) delivering said order to said customer.

2. A method of operating a business, according to claim 1, wherein said business is a restaurant and said appropriate party in step (c) is at least one of a chef and a bartender.

3. A method of operating a business, according to claim 2, wherein said appropriate party in step (c) is each of said chef and said bartender.

4. A method of operating a business, according to claim 2, wherein said system further includes an interface which enables said customer to view a menu prior to placing their order with at least one of said chef and said bartender

5. A method of operating a business, according to claim 4, wherein said on said menu is continuously updated.

6. A method of operating a business, according to claim 4, wherein said appropriate party further includes a hostess and said method includes allowing said hostess to interface with at least one of a reservation manager program, table status monitor, full restaurant overview, incoming and outgoing call log, instant messenger service entertainment controls and to allow said hostess to communicate pre-selected messages to said patrons' table.

7. A method of operating a business, according to claim 4, wherein said method further includes providing another interface in said system which enables said patron to at least one of access pre-selected advertising, a predetermined number of internet web sites, various television programs and various preselected games.

8. A method of operating a business, according to claim 7, wherein at least two of said pre-selected advertising, said internet web sites, said television programs and said preselected games can be accessed by said patron.

9. A method of operating a business, according to claim 8, wherein each of said pre-selected advertising, said internet web sites, said television programs and said preselected games can be accessed by said patron.

10. A method of operating a business, according to claim 1, wherein said method only allows certain personnel access to all interfaces.

11. A method of operating a business, according to claim 2, wherein said method enables a patron to pay their bill at a table.
